(19) United States
(12) Patent Application Publication
(10) Pub. No.: US 2011/0124815 A1
(43) Pub. Date: May 26, 2011

(54) POLYURETHANE AND PRODUCTION METHOD THEREOF

(75) Inventors: Nobuyuki Kibino, Oita-shi (JP); Kazufumi Kai, Minato-ku (JP)

(73) Assignee: SHOWA DENKO K.K., Minato-ku, Tokyo (JP)

(21) Appl. No.: 13/003,261

(22) PCT Filed: Aug. 4, 2009
(86) PCT No.: PCT/JP2009/064086

§ 371 Date: Jan. 7, 2011

(30) Foreign Application Priority Data
Aug. 5, 2008 (JP) 2008-201508

(51) Int. Cl. C08G 71/04

(52) U.S. Cl. 525/131; 525/123

(57) ABSTRACT

The invention relates to polyurethane having s excellent electric insulating property and thermal stability, obtained by a polyaddition reaction between a polyol copolymer which is a copolymer comprising as monomer units the structures represented by formulae (1) and (2) and a polyisocyanate compound:

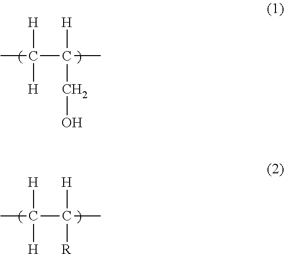

wherein R represents aliphatic hydrocarbon group having 2 to 20 carbon atoms, which may be branched and may contain a cyclic structure; and a production method thereof.

### TECHNICAL FIELD

The present invention relates to a novel polyurethane and a production method thereof.

### BACKGROUND ART

Generally, polyurethane is produced by a polyaddition reaction between a polyol compound and a polyisocyanate compound and used for rigid or flexible urethane foam, an elastomer, a paint, an adhesive agent, a coating agent, textiles and so on.

The physical properties of such a polyurethane compound can be controlled by selection of a polyol compound and a polyisocyanate compound as a material. Actually, improvement of various physical properties of the compound such as water resistance, acid resistance, alkali resistance, heat stability, electrical insulation property, mechanical strength and so on by various combinations of a compound having a polyol skeleton and a compound having a polyisocyanate skeleton has been reported. However, though efforts have been made to improve the electrical insulation property among the above-mentioned physical properties, a polyurethane compound equivalent to a polyolefin compound having high insulation reliability has not been found yet.

For example, polybutadiene polyol in liquid form and castor oil have been known as a polyol material to be able to generate polyurethane having high insulation reliability. However, the electrical insulation property of the polyurethane obtained by using these materials is inferior to that of polyethylene and polypropylene, and has a problem of insufficient thermal stability due to the large number of double bonds in the structure of liquid polybutadiene and castor oil.

JP-A-H05-247169 reports that polyurethane can be improved in electrical insulation properties by using mixed polyol of liquid polybutadiene polyol and castor oil as a polyol component and aliphatic or alicyclic polyisocyanate as a polyisocyanate component. However, the electrical insulation property of the polyurethane is inferior to that of polyethylene and polypropylene, and has a problem of insufficient thermal stability owing to that liquid polybutadiene and castor oil having double bonds in the structure are used as a polyol component.

JP-A-H06-295620 reports that polyurethane using mixed polyol of low molecular weight polyalcohol and castor oil as a polyol component exhibits excellent electrical isolation. However, the improvement of the electrical insulation property of the polyurethane has not been sufficient.

In addition, JP-A-H09-324027 reports that polyurethane using as a polyol component liquid polyesterpolyol having an iodine number of 50 or less obtained by a reaction between fatty acid and polyalcohol can be used as an electrical insulating material. Though the thermal stability is improved in the polyurethane since it contains few double bonds in polyol, the electrical insulation property of the polyurethane has not come up to that of polyethylene and polypropylene.

JP-A-H05-170867 reports a method of using a hydride of liquid polybutadiene polymer containing hydroxyl groups and a hydride of liquid polyisoprene polymer containing hydroxyl groups for the same objective to improve thermal stability. Though the thermal stability is also improved in the polyurethane since it contains few double bonds in polyol, the electrical insulation property of the polyurethane has not come up to that of polyethylene and polypropylene.

Because of these factors, development of polyurethane having excellent electric insulating property comparable to that of polyethylene and polypropylene has been demanded.

### PRIOR ART DOCUMENTS

### [Patent Documents]

### [Patent Document 1] JP-A-H05-247169

### [Patent Document 2] JP-A-H06-295620

### [Patent Document 3] JP-A-H09-324027

### [Patent Document 4] JP-A-H05-170867

### DISCLOSURE OF THE INVENTION

### Problems to be Solved by the Invention

An objective of the present invention is to provide a novel polyurethane which is excellent in electric insulating property and thermal stability and a method for producing the polyurethane efficiently.

### Means to Solve the Problem

As a result of intensive study to solve the above-mentioned problem, the present inventors have found that polyurethane comprising a copolymer of allyl alcohol and radical polymerizable aliphatic olefin compound as a polyol component can solve the above problem and has accomplished the present invention based on the finding.

That is, the present invention relates to the following [1] to [13].

[1] Polyurethane obtained by a polyaddition reaction between a polyol copolymer which is a copolymer comprising as monomer units the structures represented by formulae (1) and (2) and a polyisocyanate compound:

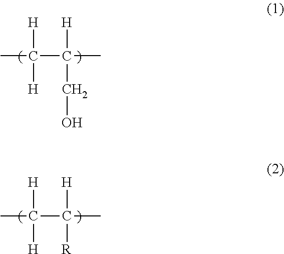

wherein R represents aliphatic hydrocarbon group having 2 to 20 carbon atoms, which may be branched and may contain a cyclic structure.
[2] The polyurethane as described in [1] above, which is obtained by a polyaddition reaction between a polyol copolymer which is a copolymer comprising as monomer units the structures represented by formulae (1) and (2) only and a polyisocyanate compound.
[3] The polyurethane as described in [1] or [2] above, which is obtained by a polymerization reaction with a polyisocyanate compound using the other polyol in combination.
[4] The polyurethane as described in [3] above, wherein the other polyol is polyester polyol obtained by a reaction between the polyol copolymer as described in [1] above and polycarboxylic acid.
[5] The polyurethane as described in any one of [1] to [4] above, which is obtained by a polymerization reaction with a polyisocyanate compound further using at least one member selected from a polyol compound and a polyamine compound in combination as a chain extension agent and/or a crosslinking agent.
[6] The polyurethane as described in [1] or [2] above, wherein the aliphatic hydrocarbon group having 2 to 20 carbon atoms represented by R in formula (2) is a linear aliphatic hydrocarbon group having 2 to 10 carbon atoms.
[7] The polyurethane as described in [1] or [2] above, wherein the aliphatic hydrocarbon group having 2 to 20 carbon atoms represented by R in formula (2) is an alicyclic hydrocarbon group having 6 to 10 carbon atoms.
[8] The polyurethane as described in any one of [1] or [8] above, wherein the hydroxyl number of the polyol copolymer is 50 to 500 mg KOH/g.
[9] The polyurethane as described in [1] or [2] above, wherein the number average molecular weight (Mn) of the polyol copolymer is 400 to 8000.
[10] A method for producing polyurethane comprising a polyaddition reaction between a polyol copolymer which is a copolymer comprising as monomer units the structures represented by formulae (1) and (2) and a polyisocyanate compound:

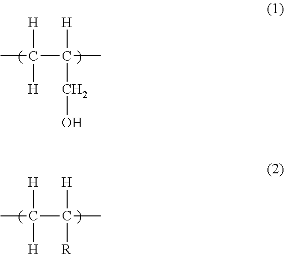

wherein R represents aliphatic hydrocarbon group having 2 to 20 carbon atoms, which may be branched and may contain a cyclic structure.
[11] The method for producing polyurethane as described in [10] above, comprising a polyaddition reaction between a polyol copolymer which is a copolymer comprising as monomer units the structures represented by formulae (1) and (2) only and a polyisocyanate compound.
[12] The method for producing polyurethane as described in [10] or [11] above, comprising a polymerization reaction with a polyisocyanate compound using the other polyol in combination.
[13] The method for producing polyurethane as described in any one of [10] to [12] above, comprising a polymerization reaction with a polyisocyanate compound further using at least one member selected from a polyol compound and a polyamine compound in combination as a chain extension agent and/or a crosslinking agent.

Since the polyurethane obtained by the present invention is excellent in the electrical insulation property and thermal stability, it is useful as an electric-cable connection material, an injection-type insulation material for electric parts and an insulating sealant.

### BRIEF DESCRIPTION OF DRAWINGS

FIG. 1 The ¹H-NMR spectrum of polyol A obtained in Synthesis Example 1

FIG. 2 The ¹³C-NMR spectrum of polyol A obtained in Synthesis Example 1

FIG. 3 The IR spectrum of polyol A obtained in Synthesis Example 1

FIG. 4 The IR spectrum of the copolymer obtained in Example 1

### BEST MODE FOR CARRYING OUT THE INVENTION

The present invention is to be explained in more details hereinafter. The polyurethane of the present invention is obtained by a polyaddition reaction between a polyol copolymer which is a copolymer comprising allyl alcohol and a monomer unit derived from an olefin compound having a linear aliphatic hydrocarbon group or an alicyclic hydrocarbon group (which may be simply referred to as “polyol copolymer” hereinafter).

### [Polyol Copolymer]

The polyol copolymer used in the present invention is a copolymer comprising as monomer units the structure represented by formula (1):

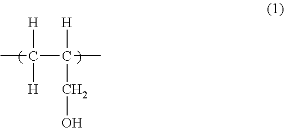

and the structure represented by formula (2):

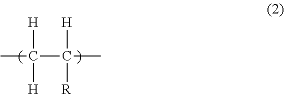

R in formula (2) represents an aliphatic hydrocarbon group having 2 to 20 carbon atoms, which may be linear or branched or may include a cyclic structure.

Examples of linear aliphatic hydrocarbon group include ethyl group, n-propyl group, n-butyl group, n-pentyl group, n-hexyl group, n-octyl group, n-decyl group, n-dodecyl group, n-tetradecyl group, n-hexadecyl group, n-octadecyl group and n-eicosyl group.

Examples of branched aliphatic hydrocarbon group include isopropyl group, isobutyl group, sec-butyl group, neopentyl group, isohexylgroup, isooctyl group and isodecyl group.

Examples of aliphatic hydrocarbon group containing a cyclic structure include cyclohexyl group, cyclohexenyl group, cyclohexylmethyl group, cyclohexylethyl group and decahydronaphthalenyl group.

Preferred among them as R are linear aliphatic hydrocarbon group having 2 to 10 carbon atoms and alicyclic hydrocarbon group having 6 to 10 carbon atoms in consideration for enhancement in compatibility with various resins. Particularly preferred in consideration for enhancement in compatibility with various resins are ethyl group, n-propyl group, n-butyl group, n-pentyl group, n-hexyl group, n-octyl group, n-decyl group, and cyclohexyl group.

There is no particular limitation on the polyol copolymer of the present invention as long as the polyol copolymer comprises the structures represented by formulae (1) and (2). The monomer unit represented by formula (1) may be obtained by using allyl alcohol as a monomer or by polymerizing the other monomer and then subjecting it to modification. Examples of the latter include the monomer unit obtained by copolymerizing allyl acetate and subjecting it to hydrolysis and ester exchange. If necessary, a third monomer may be copolymerized in the polyol copolymer within a range which does not affect the effects of the present invention. Two or more kinds of such third monomers may be introduced.

Examples of the third monomer include a vinyl compound and a divinyl compound. Specifically, the examples include dimethyl maleate, diethyl maleate, dimethyl fumarate, diethyl fumarate, dimethyl itaconate, diethyl itaconate, dicyclopentaziene, norbornene, 4-vinyl-1-cyclohexene, styrene and divinylbenzene. In the case of using a divinyl compound, it should be kept to a small amount so as to avoid a crosslinking reaction at the time of copolymerization.

In the polyol copolymer of the present invention, the bonding mode of the copolymer of the monomer unit represented by formula (1) and the monomer unit represented by formula (2) may be random, block or alternate, depending on polymerization conditions. In consideration for enhancement in compatibility with various resins, random mode is preferred.

In the polyol copolymer of the present invention, the composition of the monomer unit represented by formula (1) can be controlled by changing the blending ratio between the allyl alcohol corresponding to the monomer unit represented by formula (1) and the olefin compound corresponding to the monomer unit represented by formula (2) at the time of conducting polymerization. In consideration for achieving a good balance between the reactivity with an isocyanate compound and the electric insulation property of the product polyurethane, it is preferred that the concentration of the monomer unit represented by formula (1) be from 3 to 60 mol %, more preferably 10 to 50 mol %, most preferably 20 to 45 mol %. If the concentration of the monomer unit represented by formula (1) is less than 3 mol %, the reactivity with an isocyanate compound is markedly reduced, and if it exceeds 60 mol %, it may degrade the electric insulation property of the product polyurethane.

It is preferred that the hydroxyl value of the polyol copolymer used in the present invention be from 50 to 500 mg KOH/g in consideration for achieving a good balance between the reactivity with an isocyanate compound and the electric insulation property of the product polyurethane. If the hydroxyl value of the copolymer is less than 50 mg KOH/g, the reactivity with an isocyanate compound is markedly reduced, and if it exceeds 500 mg KOH/g, it degrades the electric insulation property of the product polyurethane. Here, the hydroxyl value is measured according to the method described in JIS K0070.

There is no particular limitation on the number average molecular weight (Mn) of the polyol copolymer of the present invention in terms of polystyrene, which is measured by gel permeation chromatography (GPC). In consideration for ease in handling for various purposes, it is preferred that Mn be from 400 to 8000. If the number average molecular weight (Mn) in terms of polystyrene is less than 400, compatibility with solid isocyanate decreases and if it exceeds 8000, the viscosity of the composition at the time of preparing polyurethane becomes markedly high, which makes it hard to handle.

### [Production Method of the Polyol Copolymer]

Next, the methods for producing the polyol copolymer of the present invention are explained. The polyol copolymer used in the present invention can be produced by either of the two methods, Method A and Method B, described below.

### Method A:

An allyl alcohol corresponding to the monomer unit represented by formula (1) and an olefin compound corresponding to the monomer unit represented by formula (2) are copolymerized in the presence of a radical polymerization initiator.

### Method B:

A copolymer of an allyl alcohol and an aromatic radically-polymerizable monomer is hydrogenated.

Method A: Radical copolymerization between an allyl alcohol and an olefin compound corresponding to the monomer unit represented by formula (2)

There is no particular limitation on the olefin compound corresponding to the monomer unit represented by formula (2) used in the production of the polyol copolymer of the present invention as long as the compound can be radically polymerizable. When expressing the structures described in the above detailed description about the polyol copolymer as olefin compounds, examples include straight chain terminal olefins such as 1-butene, 1-pentene, 1-hexene, 1-heptene, 1-octene, 1-decene, 1-dodecene, 1-tetradecene, 1-hexadecene, 1-octadecene, 1-eicosene and 1-tricosens; terminal olefins having a branched terminal such as 3-methyl-1-butene, 4-methyl-1-pentene, 3-methyl-1-pentene, 4,4-dimethyl-1-pentene, 3-methyl-1-heptene, 3-methyl-1-nonene and 3-methyl-1-undecene; and terminal olefins having a cyclic structure such as cyclohexyl ethylene, 4-vinyl-1-cyclohexene, 3-cyclohexyl-1-propene, 4-cyclohexyl-1-butene and decahydronaphthalenyl ethylene. In case of using olefin compound having an unsaturated bond at 2-position, such as 2-decene, polymerization is difficult due to resonance stabilization of living radicals.

Among them, particularly preferred in consideration for enhancement in compatibility with various resins are 1-butene, 1-pentene, 1-hexene, 1-heptene, 1-octene, 1-decene, 1-dodecene and cyclohexylethylene.

As for amounts of the allyl alcohol and the olefin compound corresponding to the monomer unit represented by formula (2) used in this copolymerization reaction, it is preferred that the amount of the allyl alcohol be from 0.05 to 2.0 mol based on 1 mol of the olefin compound corresponding to the monomer unit represented by formula (2), particularly preferably 0.1 to 1.0 mol. If the amount of the allyl alcohol is less than 0.05 mol, the hydroxyl value of the obtained copolymer becomes too low, and if it exceeds 2.0 mol, the yield of the copolymer markedly decreases.

This copolymerization reaction may be conducted without a solvent or conducted with a solvent which does not react with the substrates and which has a small chain transfer constant. Example of such solvents include hydrocarbon solvents such as toluene, benzene and t-butylbenzene, ketone solvents such as acetone, and halogen solvents such as dichloromethane, chloroform, and chlorobenzene. One of these solvents may be used independently or two or more of them may be used in combination.

This copolymerization reaction may be conducted by using a radical polymerization initiator. Any radical polymerization initiator may be used as long as it can generate radicals by heat, ultraviolet ray, electron beam, radiation or the like. Preferred are those having a half-life time of 1 hour or more at the reaction temperature.

Examples of heat radical polymerization initiator include azo compounds such as 2,2′-azobisisobutyronitrile, 2,2′-azobis(2,4-dimethylvaleronitrile), 2,2′-azobis(2-methylbutyronitrile), dimethyl 2,2′-azobisisobutyrate, 4,4′-azobis(4-cyanopentanoic acid), and 2,2′-azobis(2,4,4-trimethylpentane);

ketone peroxides such as methylethyl ketone peroxide, methylisobutylketone peroxide and cyclohexanone peroxide;
diacyl peroxides such as benzoyl peroxide, decanoyl peroxide and lauroyl peroxide;
dialkyl peroxides such as dicumyl peroxide, t-butylcumyl peroxide and di-t-butyl peroxide;
peroxyketals such as 1,1-di(t-hexylperoxy)-3,3,5-trimethylcyclohexane, 1,1-bis(t-hexylperoxy)cyclohexane, 1,1-di-t-butylperoxycyclohexane and 2,2-di(t-butylperoxy)butane;
alkylperoxy esters such as t-butylperoxypivalate, t-butylperoxy-2-ethylhexanoate, t-butylperoxyisobutyrate, di-t-butylperoxyhexahydroterephthalate, di-t-butylperoxyazelate, t-butylperoxy-3,5,5-trimethylhexanoate, t-hexylperoxy-2-ethylhexanoate, 1,1,3,3-tetramethylbutylperoxy-2-ethylhexanoate, t-butylperoxyacetate, t-butylperoxybenzoate, di-t-butylperoxytrimethyladipate, t-hexylperoxyisopropylmonocarbonate, t-butylperoxylaurate, and t-hexylperoxybenzoate;
peroxycarbonates such as diisopropylperoxydicarbonate, di-sec-butylperoxydicarbonate, and t-butylperoxyisopropyl carbonate; and hydrogen peroxides, but are not limited to these examples. One of these heat radical polymerization initiators may be used independently or two or more of them may be used in combination.

Examples of initiator for radical polymerization with UV, electron beam or radiation include acetophenone derivatives such as acetophenone, 2,2-dimethoxy-2-phenylacetophenone, diethoxyacetophenone, 1-hydroxy-cyclohexylphenylketone, 2-methyl-methyl-1-[4-(methylthio)phenyl]-2-morpholinopropanone-1,2-benzyl-2-dimethylamino-1-(4-morpholinophenyl)-butanone-1, and 2-hydroxy-2-methyl-1-phenylpropane-1-one;

Benzophenone derivatives such as benzophenone, 4,4′-bis(dimethylamino)benzophenone, 4-trimethylsilylbenzophenone and 4-benzoyl-4′-methyldiphenylsulfide;
Benzoin derivatives such as benzoin, benzomethylether, benzoinpropylether, benzoinisobutylether and benzoinisopropylether;
methylphenylglyoxylate, benzoindimethylketal, and 2,4,6-trimethylbenzoyldiphenylphosphineoxide, but are not limited to these examples. One of these initiators for radical polymerization with UV, electron beam or radiation may be used independently or two or more of them may be used in combination.

The use amount of the polymerization initiator varies depending on the reaction temperature and composition ratio of allyl alcohol and the olefin compound which corresponds to the monomer unit represented by formula (2) and cannot be flatly defined. Generally, it is preferred that the amount be 0.1 to 15 parts by mass based on 100 parts by mass of the total amount of allyl alcohol, the olefin compound which corresponds to the monomer unit represented by formula (2) and a third monomer which may be added if needed, particularly preferably 1 to 10 parts by mass. If the amount of the radical polymerization initiator to be added is less than 0.1 parts by mass, polymerization reaction does not readily proceed and the addition in an amount exceeding 15 parts by mass is not desirable in consideration for the cost.

The reaction temperature (polymerization temperature) may be appropriately determined according to the type of the polymerization initiator. The temperature may be gradually changed in conducting the reaction (polymerization). In case of UV polymerization, room temperature may be employed. In case of heat polymerization, it is preferable that the reaction temperature be determined appropriately according to decomposition temperature of the initiator and generally, a preferred range is from 50 to 180° C. and a particularly preferred range is from 70 to 170° C. If the temperature is lower than 50° C., the reaction speed becomes extremely low and if it exceeds 180° C., not only decomposition of the radical initiator but also chain transfer proceeds too fast, which tends to reduce the molecular weight of the obtained copolymer.

After the reaction is completed, the polyol copolymer as a reaction product is isolated by known operations and treatments (such as neutralization, solvent extraction, washing with water, liquid separation, distilling-off of solvent and reprecipitation). As presented above, the polyol copolymer may be obtained by radical copolymerization using allyl acetate in place of allyl alcohol and subsequent hydrolysis and ester exchange. The hydrolysis reaction can be conducted by treating the polymer after copolylmerization with an acid or alkali aqueous solution. The ester exchange reaction can be conducted by reacting the allyl acetate copolymer with alcohols such as ethanol, propanol and butanol in the presence of acid or alkali.

Method B: Hydrogenation of a copolymer of an allyl alcohol and a radically polymerizable aromatic monomer

In Method B, first, a copolymer of an allyl alcohol and a radically polymerizable aromatic monomer is obtained. The aromatic ring of the copolymer is hydrogenated (hydrogenation). As such a copolymer of an allyl alcohol and a radically polymerizable aromatic monomer, a copolymer (allyl alcohol/styrene copolymer) obtained according to the method described in U.S. Pat. No. 5,444,141 or those commercially available may be used.

Examples of radically polymerizable aromatic monomer include styrene and vinyl toluene.

The hydrogenation reaction can be carried out by allowing an allyl alcohol, a radically polymerizable aromatic monomer and hydrogen gas to contact with each other in the presence of a catalyst.

Examples of catalyst used in the hydrogenation reaction include those containing as a catalyst component at least one metal element selected from Groups 6 to 12 in the periodic table. Specific examples thereof include catalysts comprising a combination selected from sponge nickel, Ni-diatomite, Ni-alumina, Ni-silica, Ni-silica-alumina, Ni-zeolite, Ni-titania, Ni-magnesia, Ni-chromia, Ni—Cu, Ni—Cu—Co, sponge Co, Co-diatomite, Co-alumina, Co-silica, Co-silica-alumina, Co-zeolite, Co-titania, Co-magnesia, sponge-Ru, Ru-carbon, Ru-alumina, Ru-silica, Ru-silica alumina, Ru-zeolite, Rh-carbon, Rh-alumina, Rh-silica, Rh-silica-alumina, Rh-zeolite, Pt-carbon, Pt-alumina, Pt-silica, Pt-silica-alumina, Pt-zeolite, Pd-carbon, Pd-alumina, Pd-silica, Pd-silica alumina and Pd-zeolite. Preferred among them are catalysts containing Rh, Ru or Pd as the catalyst component and particularly preferred are catalysts of Rh-carbon, Ru-carbon, Ru-alumina, Pd-carbon, and Pd-alumina.

There is no particular limitation on the method of preparing the catalyst and generally used method may be employed. Examples of the method include a method in which a carrier impregnated with a solution of a salt of a metal to serve as the catalyst is subjected to reduction treatment by using a reducing agent;

a method in which a carrier is impregnated with a solution of a salt of a metal to serve as the catalyst, allowed to contact with an alkali solution or the like to thereby precipitate metal oxide or oxide on the carrier, followed by calcining the oxide; a method in which a carrier is impregnated with a solution of a salt of a metal to serve as the catalyst, allowed to contact with an alkali solution or the like to thereby precipitate metal oxide or oxide on the carrier, followed by calcining the oxide, and then the resultant is subjected to reduction treatment by using a reducing agent; and a method in which an alloy of a metal and Al is prepared and the alloy is subjected to alkali treatment to thereby elute out Al. The present invention is not limited by these examples.

It is preferred that the hydrogenation reaction be conducted in liquid phase with a solvent for the purpose of removing reaction heat and reducing diffusion efficiency of hydrogen due to increase in viscosity. Any solvent can be used in the reaction as long as the solvent does not disturb the reaction. Specific examples thereof include one selected from halogenated hydrocarbons such as dichloromethane, chloroform, and 1,2-dichloroethane; aliphatic hydrocarbon solvents such as pentane, hexane, heptane and octane; ether solvents such as

diethylether, dipropylether, diisopropylether, dibutylether, ethyleneglycol dimethylether, ethyleneglycol diethylether, ethyleneglycol dibutylether, diethyleneglycol dimethylether, diethyleneglycol diethylether, diethyleneglycol dibutylether, tetrahydrofuran, and 1,4-dioxane; ether alcohol solvents such as 2-methoxyethanol, 2-ethoxyethanol, 2-propoxyethanol, 2-isopropoxyethanol, 2-butoxy ethanol, diethyleneglycol monomethylether, diethyleneglycol monoethylether, propyleneglycol monomethylether and propyleneglycol monoethylether; alcohol solvents such as methanol, ethanol, 1-propanol, 2-propanol, 1-butanol, 2-butanol, isobutyl alcohol and cyclohexanol; water; and a mixture solvent containing two or more of these solvents.

Preferred among them in consideration for solubility of hydrogen or the copolymer of an allyl alcohol and a radically polymerizable aromatic monomer are ether solvents and halogenated hydrocarbon solvents, and particularly preferred are tetrahydrofuran, 1,4-dioxane and chloroform.

As for hydrogen pressure in the hydrogenation reaction, the reaction may be carried out under normal pressure or increased pressure. In order for the reaction to proceed efficiently, increased pressure is preferred. Generally the reaction is carried out under a gauge pressure of 0 to 30 MPaG, preferably 1 to 20 MPaG, more preferably 2 to 15 MPaG.

Within a range that does not decrease the reaction efficiency of the catalyst, any temperature may be employed in the hydrogenation reaction. A general temperature range is 0 to 300° C., preferably 50 to 250° C., more preferably 70 to 220° C. If the temperature is too high, side-reactions readily occur and if the temperature is too low, practically useful reaction speed cannot be obtained.

As for the reaction mode of the hydrogenation reaction, any reaction mode generally used in general liquid-phase hydrogenolysis reaction or liquid-phase hydrogenation reaction, such as suspension bed batch reaction, fixed bed flow reaction and fluid bed flow reaction, may be employed according to the reaction process. The amount of the catalyst used in the reaction varies depending on the reaction mode and there is no particular limitation on the amount. In a batch process using a suspension bed, generally a range of the amount of the catalyst is 0.01 to 100 parts by mass based on 100 parts by mass of the copolymer of the allyl alcohol and the radically polymerizable aromatic monomer as the substrate, preferably 0.1 to 50 parts by mass, more preferably 0.5 to 20 parts by mass.

If the amount is too small, practically sufficient reaction speed cannot be obtained and if the amount is too large, side-reactions increase and costs for the catalyst also increases.

After completion of the hydrogenation reaction, the allyl alcohol copolymer as the reaction product is isolated by known procedures and treatment (such as filtration, eluting out with solvent, washing with water, separation, distilling-off of solvent and reprecipitation).

The polyol copolymer of the present invention may be used in combination with the other polyols. There is no particular limitation on the other polyols to be used as long as the polyol can be reacted with a polyisocyanate compound. Specific examples include linear aliphatic diols such as ethylene glycol, propylene glycol, 1,3-propane diol, 1,4-butane diol, 1,6-hexane diol and neopentyl glycol; diols having a repeating unit of an alicyclic structure such as 1,4-cyclohexane dimethanol, hydrogenated bisphenol-A and tricyclodecane dimethanol; aromatic diols such as bisphenol-A and xylylene diol; (poly)ether glycols such as diethylene glycol, triethylene glycol, polyethylene glycol, polytrimethylene glycol and polytetraethylene glycol; polyester polyols such as polyethylene adipate, polytrimethylene adipate, polytetramethylene adipate, polyhexamethylene adipate, polyneopentylene adipate and polycaprolactam; and furthermore, diols such as polyester polyol and polycarbonate diol obtained by the reaction between the polyol copolymer of the present invention and polycarboxylic acid. However, the present invention is not limited thereto.

In the production of the polyester polyol obtained by the esterification reaction between the polyol copolymer of the present invention and polycarboxylic acid, there is no particular limitation on the polycarboxylic acid to be used as long as it has two or more carboxylic groups. Examples include oxalic acid, malonic acid, succinic acid, glutaric acid, adipic acid, pimelic acid, suberic acid, azelaic acid, sebacic acid, phthalic acid, isophthalic acid, terephthalic acid, maleic acid and fumaric acid.

As an embodiment of the esterification reaction, methods for producing common polyester polyol can be used as they are. That is, a method of reacting the polyol copolymer compound and a polycarboxylic acid compound in the presence or absence of catalysts can be used.

As catalysts, catalysts generally used in a polycondensation reaction in the synthesis of general polyester can be used and inorganic acid, organic acid, Lewis acid and so on can be used.

The polycondensation reaction can be conducted in or without a solvent. There is no particular limitation on a solvent as long as it is capable of dissolving polyol copolymer and polycarboxylic acid without inhibiting the polycondensation reaction, and examples include aromatic hydrocarbons such as toluene and xylene.

Though there is no particular limitation on the ratio of polyol copolymer and carboxylic acid, generally, the ratio is adjusted so that the final ratio of the number of the carboxyl groups (COOH groups) of the polycarboxylic acid compound and the number of hydroxyl groups (OH groups) to be reacted becomes less than one. That is, the blending ratio of each of raw materials is determined so that the ratio of the total molar equivalent of the OH group of the polyol copolymer compound and the total molar equivalent of the COOH group of the polycarboxylic acid: i.e. OH/COOH, becomes preferably in the range of from 1.1 to 2.0, more preferably in the range of from 1.2 to 1.7. In the case of a blending ratio with a high proportion of carboxyl groups, it becomes difficult to generate polyester polyol because the terminals of the polyol become carboxyl groups. In the case of a blending ratio with too excessive hydroxyl groups, the polyol copolymer will remain unreacted.

Though the ratio of the polyol copolymer and the other polyols can be arbitrarily adjusted, the ratio of the polyol copolymer to be used is generally 20 to 100 mol %, preferably 40 to 100 mol %, more preferably 50 to 100 mol % so as to achieve the desired effect of the present invention. If the ratio of the polyol copolymer is less than 20 mol %, the electric insulation property becomes insufficient.

### [Polyisocyanate Compound]

There is no particular limitation on the polyisocyanate compound used for the synthesis of the polyurethane of the present invention as long as it can be used for the synthesis of typical polyurethane and it is a compound having plural isocyanato groups (—N═C═O). Specific examples of the compound having two isocyanato groups in a molecule include diisocyanate such as 4,4-diphenylmethane diisocyanate (MDI), polymeric MDI, trilene diisocyanate (TDI), 1,5-naphthalene diisocyanate (NDI), hexamethylene diisocyanate (HDI), xylylene diisocyanate (XDI), 4,4′-dicyclohexylmethane diisocyanate (HMDI), isophorone diisocyanate (IPDI), tetramethylxylylene diisocyanate (TMXDI), 2,6-trilene diisocyanate, 1,3-trimethylene diisocyanate, 1,4-tetramethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate, 1,4-cyclohexane diisocyanate, 2,2′-diethylether diisocyanate, diphenylmethane-4,4′-diisocyanate, o-xylene diisocyanate, m-xylene diisocyanate, p-xylene diisocyanate, methylene-bis(4-cyclohexyl isocyanate), cyclohexane-1,3-dimethylene diisocyanate, cyclohexane-1,4-dimethylene diisocyanate, p-phenylene diisocyanate, 3,3′-methylene ditolylene-4,4′-diisocyanate, 4,4′-diphenylether diisocyanate, tetrachlorophenylene diisocyanate, norbornane diisocyanate, hydrogenated 1,3-xylylene diisocyanate and hydrogenated 1,4-xylylene diisocyante. Examples of a compound having three isocyanato groups in a molecule include triisocyanates such as triphenylmethane triisocyanate, 1,6,11-undecane triisocyanate, 1,3,6-hexamethylene triisocyanate, lysine triisocyanate; and condensation products of isocyanate such as isocyanurate. Also, a block isocyanate compound wherein an isocyanate group is protected can be used. One of these isocyanate compounds can be used independently or two or more kinds thereof may be used in combination.

### [Method for Producing Polyurethane]

The polyurethane of the present invention is obtained by a polyaddition reaction of polyol copolymer and a polyisocyanate compound. The polyurethane synthesized by using the other polyol in combination is obtained by a polyaddition reaction of polyol copolymer, a polyisocyanate compound and the other polyol.

As an embodiment of the synthesis reaction of the polyurethane of the present invention, methods for producing common polyurethane can be used as they are. That is, a method of reacting a polyisocyanate compound and a polyol compound in the presence or absence of a catalyst can be used. Also, so-called emulsion polymerization, wherein a polyisocyanate compound and a polyol compound are reacted in the presence of an organic solvent containing a surfactant and water and a catalyst; and the organic solvent is removed after the completion of the reaction, can be applied.

As a catalyst, those generally used for a polyaddition reaction in the synthesis of typical polyurethane such as an organic tin compound and an organic amine compound can be used.

In some cases, at least one member selected from a polyol compound and a polyamine compound as a chain extension agent and/or as a crosslinking agent may be added so as to change the polymerization degree of the polyurethane. In such a case, polyurethane synthesis can be performed in one stage by reacting these chain extension agent and/or a crosslinking agent, polyol copolymer and a polyisocyanate compound simultaneously. Polyurethane synthesis can also be performed in two stages by reacting polyol copolymer and a polyisocyanate compound first to thereby prepare a terminal polyisocyanate oligomer and then by reacting the obtained oligomer with a chain extension agent and/or a crosslinking agent.

There is no particular limitation on the polyol compound and the polyamine compound which can be used as a chain extension agent and/or a crosslinking agent in the synthesis of polyurethane of the present invention as long as it can be used in the synthesis of common polyurethane. Examples of such a polyol compound includes linear aliphatic diols such as ethylene glycol, propylene glycol, 1,3-propane diol, 1,4-butane diol, 1,6-hexanediol and neopentyl glycol; alicyclic diols such as 1,4-cyclohexane dimethanol, hydrogenated of bisphenol A and tricyclodecane dimethanol; aromatic diols such as bisphenol-A, xylylene diol and hydroquinone diethylol ether; (poly)ether glycols such as diethylene glycol, triethylene glycol, polyethylene glycol, polypropylene glycol, polytrimethylene glycol and polytetramethylene glycol; polyols such as trimethylol propane, trimethylol ethane, glycerin, hexane triol, pentaerithritol and sorbitol; polyester polyols such as polyethylene adipate and polytetramethylene adipate; polycaprolactone polyol; polycarbonate polyol; polybutadiene polyol; and castor oil. Specific examples of polyamine compounds include aliphatic polyamine compounds such as 3,3′-dichloro-4,4′-diaminodiphenyl methane (MOCA) and amine containing hydroxyl groups such as monoethanol amine and diethanol amine.

A polyol compound as a chain extension agent and a crosslinking agent may be the same substance as the above-mentioned “other polyols”.

The polyaddition reaction can be performed in or without a solvent. There is no particular limitation on the solvent as long as it is capable of dissolving the polyol compound and the polyisocyanate compound of the present invention without inhibiting the polycondensation reaction, and examples include aromatic hydrocarbons such as toluene and xylene. However, since water reacts with an isocyanate group, thereby inhibiting the polyaddition reaction with a polyol compound, it is preferable to use the solvent after being dewatered (dried). However, it does not hold true in the case of so-called emulsion polymerization in which reaction between isocyanate groups and water is prevented by using a surfactant.

Though there is no particular limitation on the ratio of a polyol compound (including polyol copolymer and the other polyol) and a polyisocyanate compound, generally, the ratio is adjusted so that the final ratio of the number of the isocyanato groups of the polyisocyanate compound and the number of functional groups (hydroxyl groups/amino groups) to be reacted becomes close to one. That is, the blending ratio of each of raw materials is determined so that the ratio of the total molar equivalent of the isocyanato group (NCO group) of the polyisocyanate compound, the total molar equivalent of the hydroxyl group of the polyol compound and the hydroxyl or amino group of the chain extension and/or crosslinking agent: i.e. NCO/(OH+NH), is preferably in the range of from 0.7 to 1.5, more preferably from 0.9 to 1.2. In the case of a blending ratio with too excessive functional groups (i.e. either of isocyanato groups or hydroxyl groups), either of the compounds containing excessive functional groups remain unreacted. Also, it is often the case that the obtained polyurethane does not have sufficient molecular weight to thereby fail to attain expected physical properties.

Various additives such as an antioxidant, a light stabilizer and an ultraviolet absorber may be blended in the polyurethane of the present invention.

### EXAMPLES

Hereinafter, the present invention is described in greater detail by referring to Examples and Comparative Examples. The present invention is by no means limited thereto.

Properties of products synthesized in Examples and Comparative Examples were measured as follows.

### 1. FT-IR

Apparatus used: Spectrum GX
(manufactured by PerkinElmer, Inc.)

Measurement method: measured by liquid membrane technique using a KBr plate

### 2. ¹H-NMR, ¹³C-NMR

Apparatus used: JEOL EX-400
(400 MHz; manufactured by JEOL, LTD.)
   Measurement method: measured by dissolving samples in deuterated chloroform or deuterated methanol and using tetramethylsilane as internal standard.

### 3. Gel Permeation Chromatography (GPC)

### Apparatus Used:

Column: Shodex GPC K-G+K-802+K-802.5+K-801 (manufactured by SHOWA DENKO K.K.),

Detector: Shodex SE-61 (manufactured by SHOWA DENKO K.K.),

Measurement Conditions

Solvent: Chloroform,

Measurement temperature: 40° C.,

Flow rate: 1.0 ml/minute,

Sample concentration: 1.0 mg/ml,

Injection amount: 1.0 μl,

Calibration curve: Universal Calibration curve,

Analysis program: SIC 480II (product of System Instruments, Inc.)

### 4. Hydroxyl Value

The value was measured according to the method described in JIS K0070.

### 5. Electric Permittivity

Apparatus used: Transformer Bridge TRS-10T (manufactured by Ando Electric Co., Ltd.)

### Measurement Conditions:

Frequency: 1 MHz

Temperature: 25° C.

### Measurement Method:

Permittivity was measured by the method (transformer bridge method) described in JIS C6471.

### 6. Thermal Stability

### Measurement Method:

A film-shape test sample was heated in the air at 100° C. for 30 minutes to evaluate the thermal stability by the absence or presence of hue change of the test sample after the heating.

### Synthesis Example 1

### Preparation of Polyol A (copolymerization of allyl alcohol and 1-decene)

In a 120 ml-volume stainless-steel made autoclave (manufactured by Taiatsu Techno Corporation), allyl alcohol (manufactured by Showa Denko K. K., 6.00 g, 0.103 mol), 1-decene (manufactured by Wako Pure Chemical Industries Co., Ltd., 48.30 g, 0.344 mol) and 2,2′-azobis(2,4,4-trimethyl pentane) (manufactured by Wako Pure Chemical Industries Co., Ltd., 2.72 g, 0.0107 mol) were placed. After a flange was attached, the inside of the reaction system was substituted with nitrogen three times. Next, the temperature was increased while stirring the content at 400 rpm, and reaction was carried out at 140° C. for five hours.

After the content was cooled to room temperature, depressurization was carried out. The reaction container was opened to take out the content. From the content, the allyl alcohol and 1-decene that had remained unreacted and the remaining initiator were removed under reduced pressure at 100° C. to thereby obtain 8.61 g of an oily substance having high viscosity.

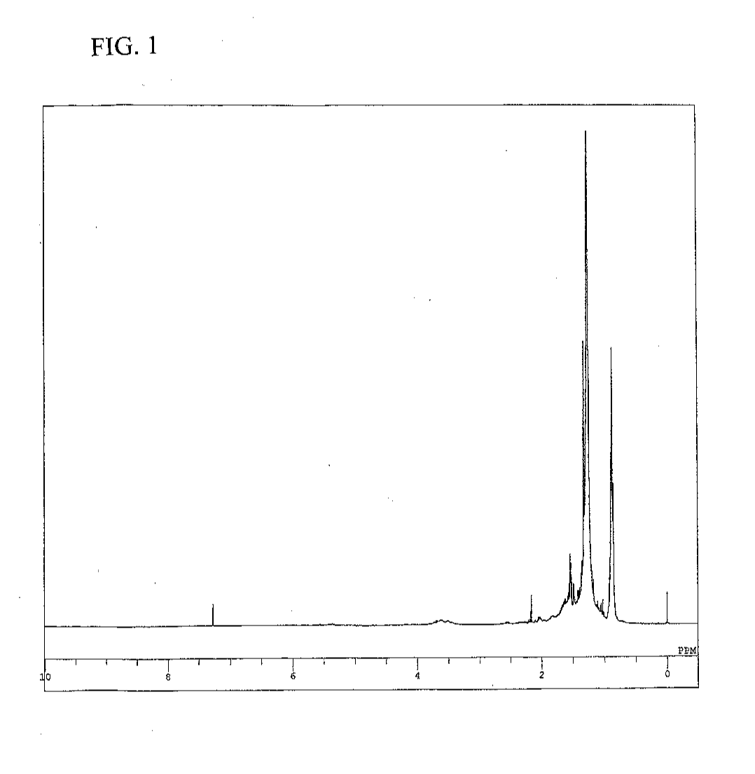

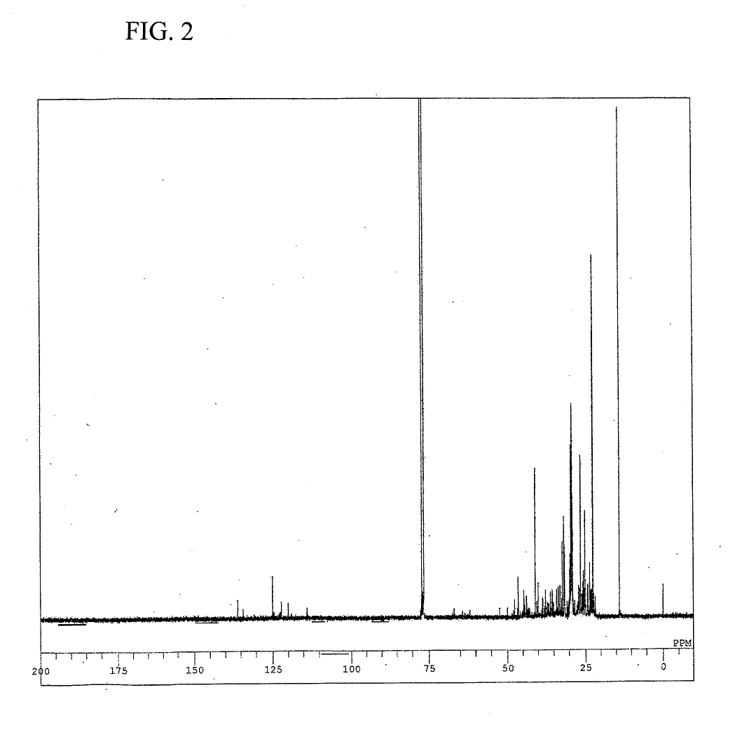

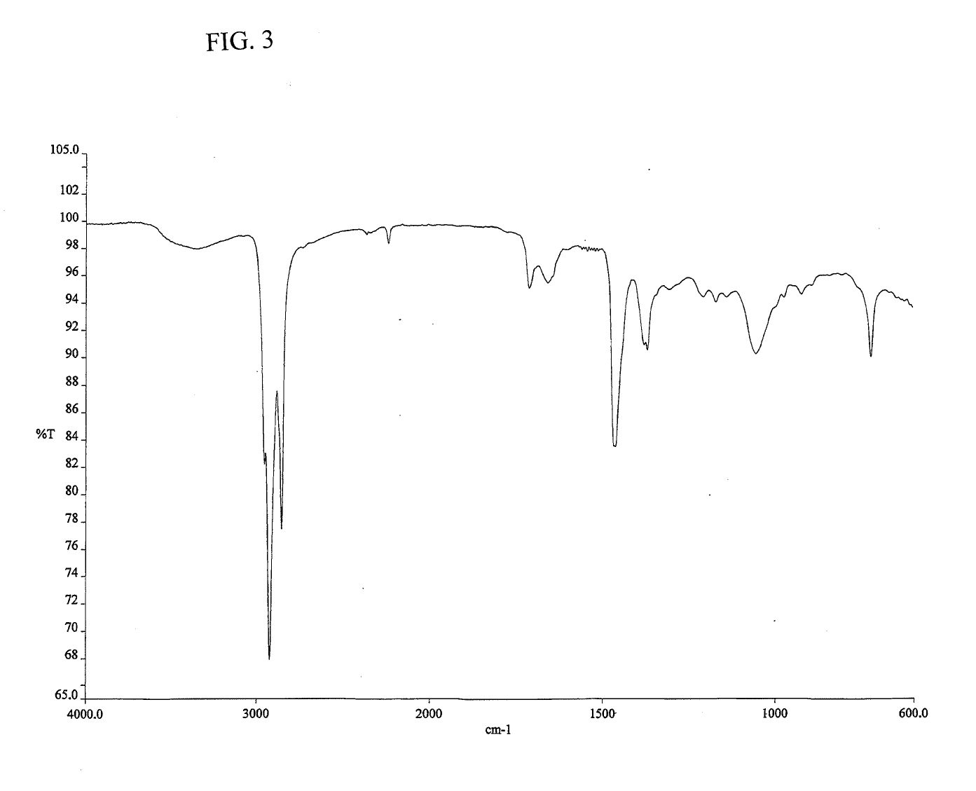

The ¹H-NMR, ¹³C-NMR and IR spectra of the obtained oily substance were measured and it was confirmed that the substance was the target copolymer (polyol A). The results of the ¹H-NMR, ¹³C-NMR and IR spectra are shown in FIGS. 1 to 3, respectively. The number average molecular weight of the copolymer (Mn) was 850, the hydroxyl value was 117 mg KOH/g, and the concentration of the allyl alcohol monomer unit was 25.0 mol %.

### Synthesis Example 2

### Preparation of Polyol B (copolymerization of allyl alcohol and 1-decene)

In a 120 ml-volume stainless-steel made autoclave (manufactured by Taiatsu Techno Corporation), allyl alcohol (manufactured by Showa Denko K. K., 8.00 g, 0.138 mol), 1-decene (manufactured by Wako Pure Chemical Industries Co., Ltd., 38.64 g, 0.275 mol) and di-t-butylperoxide (manufactured by Kanto Chemical Co., Inc., 2.33 g, 0.159 mol) were placed. After a flange was attached, the inside of the reaction system was substituted with nitrogen three times. Next, the temperature was increased while stirring the content at 400 rpm, and reaction was carried out at 140° C. for five hours.

After the content was cooled to room temperature, depressurization was carried out. The reaction container was opened to take out the content. From the content, the allyl alcohol and 1-decene that had remained unreacted and the remaining initiator were removed under reduced pressure at 100° C. to thereby obtain 9.08 g of an oily substance having high viscosity.

The ¹H-NMR, ¹³C-NMR and IR spectra of the obtained oily substance were measured and it was confirmed that the substance was the target copolymer (polyol B). The number average molecular weight of the copolymer (Mn) was 830, the hydroxyl value was 217 mg KOH/g, and the concentration of the allyl alcohol monomer unit was 41.2 mol %.

### Synthesis Example 3

### Preparation of Polyol C (hydrogenation of copolymer of allyl alcohol and styrene)

In a 120 ml-volume stainless-steel made autoclave (manufactured by Taiatsu Techno Corporation), copolymer of allyl alcohol and styrene (manufactured by Sigma-Aldrich, Inc., Mn=1200, hydroxyl value: 255 mg KOH/g, 6.0 g, allyl alcohol monomer unit: 40 mol %), 1,4-dioxane (manufactured by Wako Pure Chemical Industries Co., Ltd., 55.0 ml) and powdery 5% Rh-carbon (manufactured by Wako Pure Chemical Industries Co., Ltd., 0.7 g) were placed. After a flange was attached, the inside of the reaction system was substituted with nitrogen three times and then with hydrogen gas.

Finally, a hydrogen pressure of 4.5 MPaG (gauge pressure) was applied thereto. Next, the temperature was increased while stirring the content at 400 rpm, and reaction was carried out at 200° C. for 7 hours. During the reaction, hydrogen was introduced so that the reaction pressure was constant.

After the content was cooled to room temperature, depressurization and substitution with nitrogen were carried out. The reaction container was opened to take out the content and the content was subjected to filtration to thereby remove catalyst. From the obtained filtrate, 1,4-dioxane was distilled away under reduced pressure, to thereby obtain 5.9 g of a white solid substance.

The ¹H-NMR, ¹³C-NMR and IR spectra of the obtained white solid substance were measured and it was confirmed that the substance was the target copolymer (polyol C). The number average molecular weight of the copolymer (Mn) was 1220, the hydroxyl value was 242 mg KOH/g, and the concentration of the allyl alcohol monomer unit was 40 mol %.

### Synthesis Example 4

### Preparation of Polyol D (terpolymerization of allyl alcohol, 1-decene and dicyclopentadiene)

In a 120 ml-volume stainless-steel made autoclave (manufactured by Taiatsu Techno Corporation), allyl alcohol (manufactured by Showa Denko K. K., 10.46 g, 0.180 mol), 1-decene (manufactured by Wako Pure Chemical Industries Co., Ltd., 42.08 g, 0.300 mol), dicyclopentadiene (manufactured by Wako Pure Chemical Industries Co., Ltd., 3.97 g, 0.030 mol) and 2,2′-azobis(2,4,4-trimethyl pentane) (manufactured by Wako Pure Chemical Industries Co., Ltd., 2.83 g, 0.0111 mol) were placed. After a flange was attached, the inside of the reaction system was substituted with nitrogen three times. Next, the temperature was increased while stirring the content at 400 rpm, and reaction was carried out at 140° C. for five hours.

After the content was cooled to room temperature, depressurization was carried out. The reaction container was opened to take out the content. From the content, the allyl alcohol, 1-decene and dicyclopentadiene that had remained unreacted and the remaining initiator were removed under reduced pressure at 100° C. to thereby obtain 6.28 g of an oily substance having high viscosity.

The ¹H-NMR, ¹³C-NMR and IR spectra of the obtained oily substance were measured and it was confirmed that the substance was the target terpolymer (polyol D). The number average molecular weight of the copolymer (Mn) was 750, the hydroxyl value was 148 mg KOH/g, and the concentration of the allyl alcohol monomer unit was 30.0 mol %.

### Synthesis Example 5

### Preparation of Polyol E (copolymerization of allyl acetate and 1-decene followed by ester exchange reaction)

In a 300 ml-volume stainless-steel made autoclave (manufactured by Taiatsu Techno Corporation), allyl acetate (manufactured by Tokyo Chemical Industry Co., Ltd., 12.00 g, 0.120 mol), 1-decene (manufactured by Wako Pure Chemical Industries Co., Ltd., 84.16 g, 0.600 mol) and di-t-butylperoxide (manufactured by Kishida Chemical Co., Ltd., 4.81 g, 0.0329 mol) were placed. After a flange was attached, the inside of the reaction system was substituted with nitrogen three times. Next, the temperature was increased while stirring the content at 400 rpm, and reaction was carried out at 145° C. for six hours.

After the content was cooled to room temperature, depressurization was carried out. The reaction container was opened to take out the content. From the content, the allyl acetate and 1-decene that had remained unreacted and the remaining initiator were removed under reduced pressure at 100° C. to thereby obtain 42.11 g of an oily substance having high viscosity.

20.00 g of the oily substance, 250 ml of ethanol and sodium hydroxide (manufactured by Wako Pure Chemical Industries Co., Ltd., 0.40 g, 0.001 mol) were placed in a two-neck flask and the inside of the reaction system was substituted with nitrogen. Next, the temperature was increased while stirring the content and reaction was carried out at 80° C. for four hours. After the content was cooled to room temperature, it was passed through a column packed with 30 g of ion-exchange resin (manufactured by Mitsubishi Chemical Corporation, DAIAION PK208H) to remove the residue of sodium and next to remove ethanol and ethyl acetate under reduced pressure to thereby obtain 17.87 g of a pale yellow oily substance.

The ¹H-NMR, ¹³C-NMR and IR spectra of the obtained oily substance were measured and it was confirmed that the substance was the target copolymer (polyol E). The number average molecular weight of the copolymer (Mn) was 1640, the hydroxyl value was 88 mg KOH/g, and the concentration of the allyl alcohol monomer unit was 19.5 mol %.

### Synthesis Example 6

### Preparation of Polyol F (copolymerization of allyl acetate and 1-decene followed by ester exchange reaction)

Except that allyl acetate (manufactured by Tokyo Chemical Industry Co., Ltd., 18.02 g, 0.180 mol), 1-decene (manufactured by Wako Pure Chemical Industries Co., Ltd., 84.16 g, 0.600 mol) and di-t-butylperoxide (manufactured by Kishida Chemical Co., Ltd., 5.10 g, 0.0349 mol) were placed in the autoclave, the same reaction and subsequent treatment were performed in the same way as in Synthesis Example 5 to thereby obtain 18.16 g of a pale yellow oily substance having high viscosity.

The ¹H-NMR, ¹³C-NMR and IR spectra of the obtained oily substance were measured and it was confirmed that the substance was the target copolymer (polyol F). The number average molecular weight of the copolymer (Mn) was 1630, the hydroxyl value was 129 mg KOH/g, and the concentration of the allyl alcohol monomer unit was 27.5 mol %.

### Synthesis Example 7

### Preparation of Polyol G (copolymerization of allyl acetate and 1-decene followed by ester exchange reaction)

In a one liter-volume glass autoclave (manufactured by Taiatsu Techno Corporation), allyl acetate (manufactured by Tokyo Chemical Industry Co., Ltd., 100.10 g, 1.000 mol), 1-decene (manufactured by Wako Pure Chemical Industries Co., Ltd., 280.60 g, 2.000 mol) and di-t-butylperoxide (manufactured by Kishida Chemical Co., Ltd., 19.00 g, 0.1299 mol) were placed. After a flange was attached, the inside of the reaction system was substituted with nitrogen three times. Next, the temperature was increased while stirring the content at 400 rpm, and reaction was carried out at 145° C. for six hours.

After the content was cooled to room temperature, depressurization was carried out. The reaction container was opened to take out the content. From the content, the allyl acetate and 1-decene that had remained unreacted and the remaining initiator were removed under reduced pressure at 100° C. under reduced pressure to thereby obtain 180.50 g of an oily substance having high viscosity.

50.00 g of the oily substance, 600 ml of ethanol and sodium hydroxide (manufactured by Wako Pure Chemical Industries Co., Ltd., 0.10 g, 0.0025 mol) were placed in a one liter-volume of two-neck flask and the inside of the reaction system was substituted with nitrogen. Next, the temperature was increased while stirring the content and reaction was carried out at 80° C. for five hours. After the content was cooled to room temperature, it was passed through a column packed with 100 g of ion-exchange resin (manufactured by Mitsubishi Chemical Corporation, DAIAION PK208H) to remove the residue of sodium and next to remove ethanol and ethyl acetate under reduced pressure to thereby obtain 39.99 g of a pale yellow oily substance.

The ¹H-NMR, ¹³C-NMR and IR spectra of the obtained oily substance were measured and it was confirmed that the substance was the target copolymer (polyol G). The number average molecular weight of the copolymer (Mn) was 1880, the hydroxyl value was 207 mg KOH/g, and the concentration of the allyl alcohol monomer unit was 39.7 mol %.

### Synthesis Example 8

### Preparation of Polyol H (copolymerization of allyl acetate and 1-decene followed by ester exchange reaction)

Except that allyl acetate (manufactured by Tokyo Chemical Industry Co., Ltd., 140.14 g, 1.400 mol), 1-decene (manufactured by Wako Pure Chemical Industries Co., Ltd., 280.60 g, 0.144 mol) and di-t-butylperoxide (manufactured by Kishida Chemical Co., Ltd., 21.00 g, 0.144 mol) were placed in the autoclave, the same reaction and subsequent treatment were performed in the same way as in Synthesis Example 7 to thereby obtain 41.39 g of a pale yellow oily substance having high viscosity.

The ¹H-NMR, ¹³C-NMR and IR spectra of the obtained oily substance were measured and it was confirmed that the substance was the target copolymer (polyol H). The number average molecular weight of the copolymer (Mn) was 1770, the hydroxyl value was 256 mg KOH/g, and the concentration of the allyl alcohol monomer unit was 46.6 mol %.

### Synthesis Example 9

### Preparation of Polyol I (copolymerization of allyl acetate and 1-decene followed by ester exchange reaction)

Except that allyl acetate (manufactured by Tokyo Chemical Industry Co., Ltd., 200.20 g, 2.000 mol), 1-decene (manufactured by Wako Pure Chemical Industries Co., Ltd., 280.60 g, 2.000 mol) and di-t-butylperoxide (manufactured by Kishida Chemical Co., Ltd., 24.00 g, 0.164 mol) were placed in the autoclave, the same reaction and subsequent treatment were performed in the same way as in Synthesis Example 7 to thereby obtain 35.50 g of a pale yellow oily substance having high viscosity.

The ¹H-NMR, ¹³C-NMR and IR spectra of the obtained oily substance were measured and it was confirmed that the substance was the target copolymer (polyol I). The number average molecular weight of the copolymer (Mn) was 1650, the hydroxyl value was 350 mg KOH/g, and the concentration of the allyl alcohol monomer unit was 57.8 mol %.

### Example 1

### Formation of Polyurethane-Cast Film

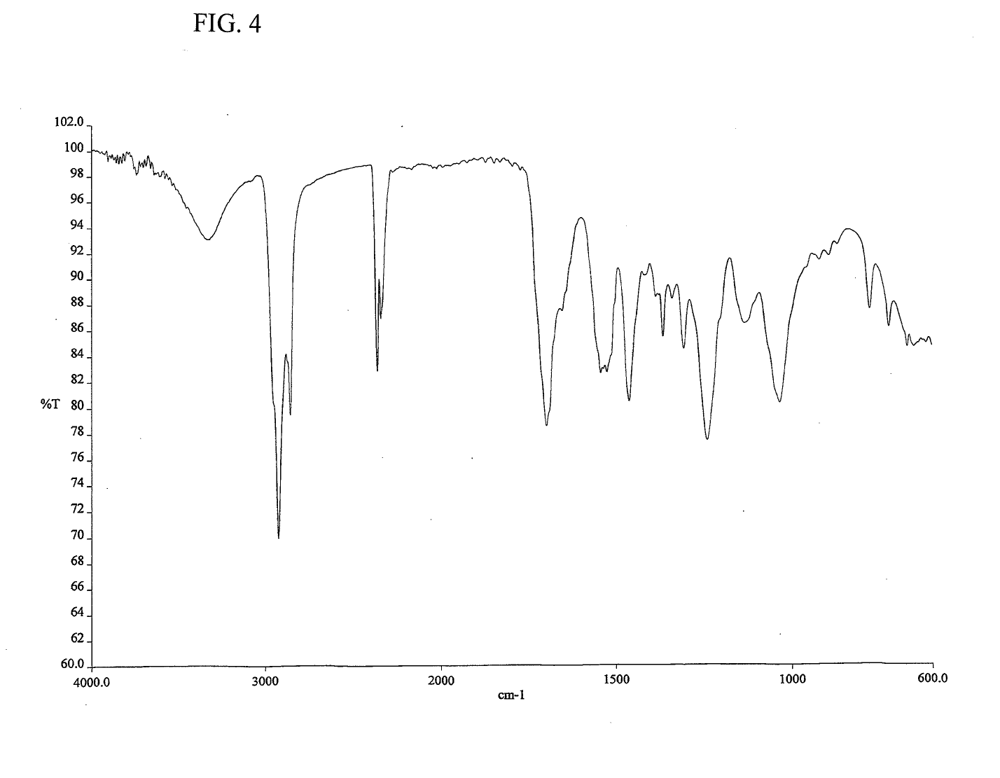

In a 20 ml sample bottle, 3.00 g of polyol A prepared in Synthesis Example 1, isophorone diisocyanate (IPDI) in an amount of 0.5 times by equivalent of the number of moles of hydroxyl groups of polyol A, and dibutyltin dilaurate (manufactured by Nitto Kasei Co., Ltd., NEOSTANN U-100, 0.012 g) were placed and stirred in a nitrogen atmosphere at room temperature for ten minutes. The mixture was applied in a thickness of about 300 μm onto a glass plate having a polytetrafluoroethylene film (trade name: Teflon) on the surface and cured by heating at 80° C. for five hours and further heating at 120° C. for three hours. Next, the resultant was cooled to room temperature and a cured film was obtained by removing the Teflon film. The measurement results of the IR spectrum of the cured film are shown in FIG. 4. The generation of a urethane bond was observed in the IR spectrum and it was confirmed that the obtained cured film was polyurethane. The measurement results of the physical properties of the cured film are shown in Table 1.

### Example 2

### Formation of Polyurethane-Cast Film

A cured film was obtained in the same way as in Example 1 except to use 3.00 g of polyol B in place of polyol A and isophorone diisocyanate in an amount of 0.5 times by equivalent of the number of moles of hydroxyl groups of polyol B. The measurement results of the physical properties of the cured film are shown in Table 1.

### Example 3

### Formation of Polyurethane-Cast Film

A cured film was obtained in the same way as in Example 1 except to use hexamethylene diisocyanate (HDI) in place of isophorone diisocyanate (IPDI). The measurement results of the physical properties of the cured film are shown in Table 1.

### Example 4

### Formation of Polyurethane-Cast Film

A cured film was obtained in the same way as in Example 2 except to use hexamethylene diisocyanate (HDI) in place of isophorone diisocyanate (IPDI). The measurement results of the physical properties of the cured film are shown in Table 1.

### Example 5

### Formation of Polyurethane Coating Film

In a 20 ml sample bottle, polyol C prepared in Synthesis Example 3 (3.00 g), isophorone diisocyanate (IPDI) in an amount of 0.5 times by equivalent of the number of moles of hydroxyl groups of polyol C and 15 ml of dry toluene were placed and stirred at room temperature for ten minutes to obtain a uniform solution. Dibutyltin dilaurate (manufactured by Nitto Kasei Co., Ltd., NEOSTANN U-100, 0.012 g) was added to the solution and the mixture was stirred in a nitrogen atmosphere at room temperature for ten minutes. The mixture was applied onto a glass plate having a Teflon (trade name) film on the surface and cured by heating at 80° C. for five hours and further heating at 120° C. for three hours. Then the glass plate was cooled to room temperature and a cured coating film was obtained by removing the Teflon film. The measurement results of the physical properties of the cured film are shown in Table 1.

### Example 6

### Formation of Polyurethane-Cast Film

A cured film was obtained in the same way as in Example 1 except to use 3.00 g of polyol D in place of polyol A and isophorone diisocyanate (IPDI) in an amount of 0.5 times by equivalent of the number of moles of hydroxyl groups of polyol D. The measurement results of the physical properties of the cured film are shown in Table 1.

### Example 7

### Formation of Polyurethane-Cast Film

A cured film was obtained in the same way as in Example 1 except to use 3.00 g of polyol E in place of polyol A and isophorone diisocyanate (IPDI) in an amount of 0.5 times by equivalent of the number of moles of hydroxyl groups of polyol E and to cure the mixture by heating at 70° C. for three hours and further heating at 120° C. for three hours. The measurement results of the physical properties of the cured film are shown in Table 1.

### Example 8

### Formation of Polyurethane-Cast Film

A cured film was obtained in the same way as in Example 1 except to use 3.00 g of polyol F in place of polyol A and isophorone diisocyanate (IPDI) in an amount of 0.5 times by equivalent of the number of moles of hydroxyl groups of polyol F and to cure the mixture by heating at 70° C. for three hours and further heating at 120° C. for three hours. The measurement results of the physical properties of the cured film are shown in Table 1.

### Example 9

### Formation of Polyurethane-Cast Film

A cured film was obtained in the same way as in Example 1 except to use 3.00 g of polyol G in place of polyol A and isophorone diisocyanate (IPDI) in an amount of 0.5 times by equivalent of the number of moles of hydroxyl groups of polyol G and to cure the mixture by heating at 70° C. for three hours and further heating at 120° C. for three hours. The measurement results of the physical properties of the cured film are shown in Table 1.

### Example 10

### Formation of Polyurethane-Cast Film

A cured film was obtained in the same way as in Example 1 except to use 3.00 g of polyol H in place of polyol A and isophorone diisocyanate (IPDI) in an amount of 0.5 times by equivalent of the number of moles of hydroxyl groups of polyol H and to cure the mixture by heating at 70° C. for three hours and further heating at 120° C. for three hours. The measurement results of the physical properties of the cured film are shown in Table 1.

### Example 11

### Formation of Polyurethane-Cast Film

A cured film was obtained in the same way as in Example 1 except to use 3.00 g of polyol I in place of polyol A and isophorone diisocyanate (IPDI) in an amount of 0.5 times by equivalent of the number of moles of hydroxyl groups of polyol I and to cure the mixture by heating at 70° C. for three hours and further heating at 120° C. for three hours. The measurement results of the physical properties of the cured film are shown in Table 1.

### Comparative Example 1

### Formation of Polyurethane-Cast Film

A cured film was obtained in the same way as in Example 1 except to use liquid hydroxyl terminated polybutadiene (manufactured by Idemitsu Kosan Co., Ltd.; R-15HT) in place of polyol A. The measurement results of the physical properties of the cured film are shown in Table 1.

### Comparative Example 2

### Formation of Polyurethane-Cast Film

A cured film was obtained in the same way as in Example 1 except to use castor oil (manufactured by Itoh Oil Chemicals Co., Ltd.; LAV) in place of polyol A. The measurement results of the physical properties of the cured film are shown in Table 1.

TABLE 1

| | | EX. 1 | EX. 2 | EX. 3 | EX. 4 | EX. 5 |
|---|---|---|---|---|---|---|
| Materials | Polyol | Polyol A | Polyol B | Polyol A | Polyol B | Polyol C |
| | Polyisocyanate | IPDI | IPDI | HDI | HDI | IPDI |
| Physical | Permittivity (%) | 2.17 | 2.20 | 2.18 | 2.22 | 2.60 |
| Properties | (25° C.) | | | | | |
| | Thermal stability | Good | Good | Good | Good | Good |
| | | EX. 6 | EX. 7 | EX. 8 | EX. 9 | EX. 10 |
| Materials | Polyol | Polyol D | Polyol E | Polyol F | Polyol G | Polyol H |
| | Polyisocyanate | IPDI | IPDI | IPDI | IPDI | IDPDI |
| Physical | Permittivity (%) | 2.28 | 2.24 | 2.27 | 2.28 | 2.31 |
| Properties | (25° C.) | | | | | |
| | Thermal | Good | Good | Good | Good | Good |
| | stability | | | | | |

| | | | Comparative | Comparative |
|---|---|---|---|---|
| | | EX. 11 | Example 1 | Example 2 |
| Materials | Polyol | Polyol I | Hydroxyl | Castor oil |
| | | | terminated | |
| | | | polybutadiene | |
| | Polyisocyanate | IPDI | IPDI | IPDI |
| Physical | Permittivity | 2.36 | 2.85 | 2.78 |
| Properties | (%) (25° C.) | | | |
| | Thermal | Good | Poor | Poor |
| | stability | | | |

IPDI: isophorone diisocyanate
HDI: hexamethylene diisocyanate

### INDUSTRIAL APPLICABILITY

The polyurethane of the present invention is useful, for example, as an electric-cable connection material, an injection-type insulation material for electric parts, an encapsulating material for semiconductors, a resin modifier, a weather-resistant paint component, a automobile paint component, a sound-proof and damping paint component, a waterproof coating component, an antirust coating component, an ink component and an adhesive component.

1. Polyurethane obtained by a polyaddition reaction between a polyol copolymer which is a copolymer comprising as monomer units the structures represented by formulae (1) and (2) and a polyisocyanate compound: 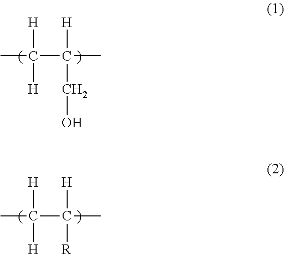
wherein R represents aliphatic hydrocarbon group having 2 to 20 carbon atoms, which may be branched and may contain a cyclic structure.

2. The polyurethane as claimed in claim 1, which is obtained by a polyaddition reaction between a polyol copolymer which is a copolymer comprising as monomer units the structures represented by formulae (1) and (2) only and a polyisocyanate compound.

3. The polyurethane as claimed in claim 1, which is obtained by a polymerization reaction with a polyisocyanate compound using another polyol in combination.

4. The polyurethane as claimed in claim 3, wherein the another polyol is polyester polyol obtained by a reaction between the polyol copolymer and polycarboxylic acid.

5. The polyurethane as claimed in claim 1, which is obtained by a polymerization reaction with a polyisocyanate compound further using at least one member selected from a polyol compound and a polyamine compound in combination as a chain extension agent and/or a crosslinking agent.

6. The polyurethane as claimed in claim 1, wherein the aliphatic hydrocarbon group having 2 to 20 carbon atoms represented by R in formula (2) is a linear aliphatic hydrocarbon group having 2 to 10 carbon atoms.

7. The polyurethane as claimed in claim 1, wherein the aliphatic hydrocarbon group having 2 to 20 carbon atoms represented by R in formula (2) is an alicyclic hydrocarbon group having 6 to 10 carbon atoms.

8. The polyurethane as claimed in claim 1, herein the hydroxyl number of the polyol copolymer is 50 to 500 mg KOH/g.

9. The polyurethane as claimed in claim 1, wherein the number average molecular weight (Mn) of the polyol copolymer is 400 to 8000.

10. A method for producing polyurethane comprising a polyaddition reaction between a polyol copolymer which is a copolymer comprising as monomer units the structures represented by formulae (1) and (2) and a polyisocyanate compound: 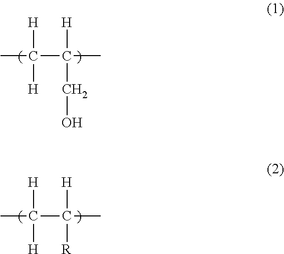
wherein R represents aliphatic hydrocarbon group having 2 to 20 carbon atoms, which may be branched and may contain a cyclic structure.

11. The method for producing polyurethane as described in claim 10, comprising a polyaddition reaction between a polyol copolymer which is a copolymer comprising as monomer units the structures represented by formulae (1) and (2) only and a polyisocyanate compound.

12. The method for producing polyurethane as claimed in claim 10, comprising a polymerization reaction with a polyisocyanate compound using another polyol in combination.

13. The method for producing polyurethane as claimed in claim 10, comprising a polymerization reaction with a polyisocyanate compound further using at least one member selected from a polyol compound and a polyamine compound in combination as a chain extension agent and/or a crosslinking agent.
